(19) United States
(12) Patent Application Publication
(10) Pub. No.: US 2026/0200761 A1
(43) Pub. Date: Jul. 16, 2026

(54) CONTROL SYSTEM FOR WATER FILTRATION EQUIPMENT

(71) Applicant: BENQ CORPORATION, Taipei City (TW)

(72) Inventor: Chin-Fu Chiang, Taipei City (TW)

(73) Assignee: BENQ CORPORATION, Taipei City (TW)

(21) Appl. No.: 19/369,347

(22) Filed: Oct. 27, 2025

(30) Foreign Application Priority Data
Jan. 10, 2025 (TW) 114101013

(51) Int. Cl. C02F 1/00; C02F 1/469

(52) U.S. Cl. CPC C02F 1/008; C02F 1/001; C02F 1/4691; C02F 2209/006; C02F 2209/40

(57) ABSTRACT

A control system is applied for a water filtration device and includes a first sensor, a water purification module and a logic controller. The first sensor is disposed on an inlet of the water filtration device to perform quality detection and to generate a harmful substance removal parameter. The water purification module is used in the water filtration device. The logic controller is electrically connected to the first sensor and the water purification module. The logic controller adjusts the harmful substance removal parameters and a taste adjustment parameter according to a preset scenario, and drives the water purification module to execute a water purification process according to an adjustment result.

### BACKGROUND OF THE INVENTION

### FIELD OF THE INVENTION

The present invention relates to a control system, and more particularly, to a control system applied for a water filtration device.

### DESCRIPTION OF THE PRIOR ART

With the advanced technology, the water filtration device is widely used in daily life to improve health quality. The conventional water filtration device can utilize a filter element to filter out impurities in the drinking water, such as polypropylene fiber cotton (PP cotton), activated carbon or ceramics. Further, the conventional water filtration device may utilize a filter membrane to filter out impurities in the drinking water, such as a nano-grade filtration membrane or a reverse osmosis membrane. Moreover, the conventional water filtration device may utilize ozone chemical disinfection, or ion exchange, or electrolysis to achieve the water purification effect. However, the filtration quality of the conventional physical water filtration technology depends on its filtration accuracy, and only a few expensive filtration materials can reach the ultrafiltration level. The conventional chemical water filtration technology can remove most impurities in the water, but has drawbacks of high energy consumption and high water pressure, and the water purification efficiency is easily affected and reduced by environmental factors. Therefore, design of a control system of making the water filtration device have preferred water filtration efficiency and provide preferred drinking taste is an important issue in the related environmental engineering industry.

### SUMMARY OF THE INVENTION

The present invention provides a control system applied for a water filtration device for solving above drawbacks.

According to the claimed invention, a control system is applied for a water filtration device and includes a first sensor, a water purification module and a logic controller. The first sensor is disposed on an inlet of the water filtration device to perform quality detection and generate a harmful substance removal parameter. The water purification module is applied for the water filtration device. The logic controller is electrically connected to the first sensor and the water purification module. The logic controller adjusts the harmful substance removal parameters and a taste adjustment parameter in accordance with a preset scenario, and drives the water purification module to execute a water purification process in accordance with an adjustment result.

The control system of the present application can utilize the first sensor to perform the quality detection in the water supply module of the water filtration device, and transmit the detection result to the logic controller for determining whether there is the harmful substance in the water. If there is the harmful substance in the water, the logic controller can compare the detection value of the harmful substance with the built-in datum of the database, and compute the harmful substance removal parameter that can completely or effectively remove the harmful substance, and the harmful substance removal parameter can be provided to the water purification module for execution of the water purification process. If there is still the specific substance that can adjust the drinking taste in the water after the water purification module performs the water purification process based on the harmful substance removal parameter, the logic controller can compute and acquire the taste adjustment parameter that meets the preset scenario, and integrate the harmful substance removal parameter and the taste adjustment parameter into the control parameter and transmit the control parameter to the water purification module.

On the contrary, if there is no specific substance that can adjust the drinking taste in the water after the water purification module performs the water purification process based on the harmful substance removal parameter, the logic controller can only transmit the harmful substance removal parameter to the water purification module. If the detection result of the first sensor decides that there is no harmful substance in the water, the logic controller can transmit the related taste adjustment parameter to the water purification module in accordance with the preset scenario. During the aforementioned stages, the control system can regularly or irregularly utilize the second sensor to perform the quality detection in the water output module of the water filtration device, and determine whether there is the harmful substance in the water, and further determine whether there is the specific substance that can adjust the drinking taste in the water, thereby immediately transmitting the detection result to the logic controller for the purpose of dynamic suppression.

Moreover, when one or plural users utilize the operation interface of the water filtration device and/or the control system to input and adjust the preset scenario, the control system of the present application can collect and store the adjustment results of the harmful substance removal parameter and/or the taste adjustment parameter of all the preset scenario during the preset period in the database, and analyze the adjustment results to form and store a learning model in the database. Later, the user only needs to input a related code via the operation interface of the water filtration device and/or the control system, and the control system can determine relevant preferences based on the learning model to automatically adjust the harmful substance removal parameter and/or the taste adjustment parameter of the preset scenario, and transmit the adjusted parameters to the water purification module for executing the water purification process and therefore acquiring the drinking water that meets their needs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an application diagram of a water filtration device and a control system according to an embodiment of the present application.

FIG. 2 is a functional block diagram of the control system according to the embodiment of the present application.

### DETAILED DESCRIPTION

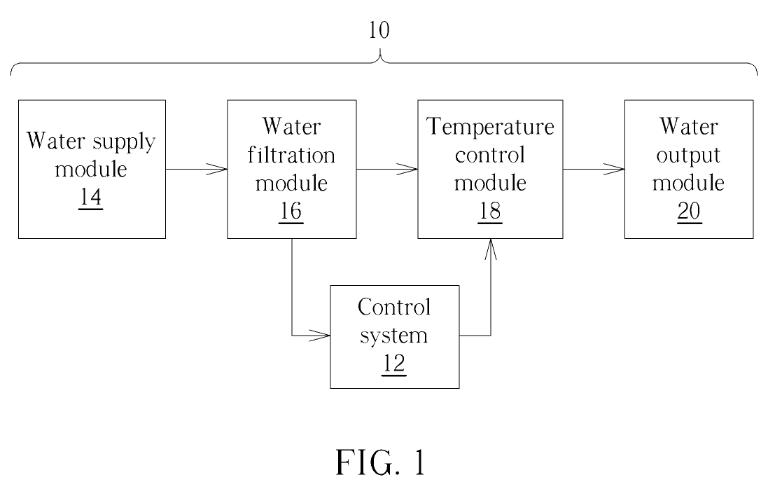

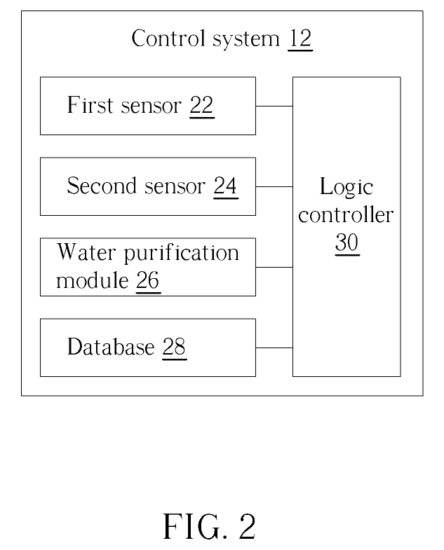

Please refer to FIG. 1 and FIG. 2. FIG. 1 is an application diagram of a water filtration device 10 and a control system 12 according to an embodiment of the present application. FIG. 2 is a functional block diagram of the control system 12 according to the embodiment of the present application. The water filtration device 10 can optionally include a water supply module 14, a water filtration module 16, a temperature control module 18 and a water output module 20. The water supply module 14 can be a water tank or a faucet, and may be equipped with a pressure pump or a pressure stabilizer to provide liquid to be filtered, such as water. The water filtration module 16 can be a physical water filtration module or a chemical water filtration module, which depends on an actual demand. The temperature control module 18 can include a heating unit and/or an ice-making unit, which is cooperated with the water output module 20 to output water of different temperatures. The control system 12 can be acted between the water supply module 14 and the water filtration module 16, for water quality detection of incoming water. The control system 12 can be further acted with the water filtration module 16 and the temperature control module 18, and used to execute a water filtration process and a water purification process. The control system 12 may be optionally acted with the temperature control module 18 and/or the water output module 20, for the water quality detection of outlet water.

The control system 12 can be cooperated with the water filtration device 10, and can include a first sensor 22, a second sensor 24, a water purification module 26, a database 28 and a logic controller 30 that are electrically connected to each other. The first sensor 22 can be disposed on an inlet of the water filtration device 10, such as the water supply module 14, and used to perform quality detection and generate a harmful substance removal parameter and/or a taste adjustment parameter. The second sensor 24 can be disposed on an outlet of the water filtration device 10, such as the water output module 20, and used to perform the quality detection and acquire a water purification result of the water purification module 26. The water purification module 26 can be applied for the water filtration device 10, and execute the water purification process to improve water quality of the water filtration device 10. In the present application, the water purification module 26 can be designed as a capacitive deionization (CDI) module, but the actual application is not limited thereto. The logic controller 30 can adjust electric field strength and/or a liquid flow rate of the capacitive deionization module to execute the water purification process, and can provide feedback information to the water purification module 26 in accordance with a detection result of the second sensor 24.

In an operation procedure of the present application, the logic controller 30 can read a preset scenario input by the user via an operation interface of the water filtration device 10 and/or the control system 12; for example, the preset scenario can be a tea mode or a coffee mode by the same person or different persons, but the actual application is not limited thereto. The operation interface can be a touch panel, a mouse or a keyboard, which is not marked in the figures. The preset scenario can be stored in the database 28, and a detailed description of the preset scenario is omitted herein for simplicity. Then, the logic controller 30 can utilize the first sensor 22 to perform the quality detection in the water supply module 14. If the detection result of the first sensor 22 indicates that there is no harmful substance in the water, the logic controller 30 can compute the taste adjustment parameter (such as concentration or a ratio of specific minerals) based on the preset scenario set by the user, and the water purification module 26 can be actuated by the acquired taste adjustment parameter to execute the water purification process, so that the water output module 20 can output drinking water that meets the user's taste.

If the detection result of the first sensor 22 indicates that there is the harmful substance in the water, the logic controller 30 can compare the detection result of the first sensor 22 with a built-in datum of the database 28, and compute the harmful substance removal parameter that is required to remove the harmful substance in the water in accordance with the preset scenario. In this situation, the logic controller 30 can compute the required harmful substance removal parameter based on types, concentrations and characteristics of the harmful substance provided by the detection result and further optionally based on the preset scenario. For example, in the coffee mode, the concentration of a certain harmful substance may need to be reduced to a low concentration range; while in the tea mode, the concentration of this harmful substance only needs to be reduced to a slightly lower range. Besides, after computation of the harmful substance removal parameter, the logic controller 30 can compute the taste adjustment parameter matched with the harmful substance removal parameter, and drive the water purification module 26 to provide the drinking water that not only meets the user's taste but also removes the harmful substance in accordance with a parameter combination of the harmful substance removal parameter and the taste adjustment parameter.

When the water purification process of the water purification module 26 is finished, the logic controller 30 can further utilize the second sensor 24 to perform the quality detection in the water output module 20, for determining whether there is a specific substance that can adjust drinking taste (such as the concentration or the ratio of various minerals) in the water, and deciding whether to adjust the harmful substance removal parameter and/or the taste adjustment parameter again, thereby achieving a purpose of dynamic suppression and feedback modification. If the detection result of the second sensor 24 indicates that there is no specific substance that can adjust the drinking taste in the water, or there is not enough specific substance that can adjust the drinking taste in the water, the logic controller 30 can only transmit the harmful substance removal parameter to the water purification module 26, and the water purification module 26 can execute the water purification process according to the latest harmful substance removal parameter and does not use the taste adjustment parameter; or, the water purification module 26 may execute the water purification process according to the latest harmful substance removal parameter and the previous taste adjustment parameter.

If the detection result of the second sensor 24 indicates that there is the specific substance that can adjust the drinking taste in the water, the logic controller 30 can compute the taste adjustment parameter in accordance with the concentration or the ratio of the specific substance, and transmit the previously-used harmful substance removal parameter and the computed taste adjustment parameter to the water purification module 26 for the following water purification process, thereby producing the drinking water that not only meets the user's taste but also removes the harmful substance. If the water from the next stage of the water purification process is found to have a lower quality or abnormality through the quality detection of the second detector 24, the harmful substance removal parameter and/or the taste adjustment parameter can be adjusted and transmitted to the water purification module 26. If the water from the next stage of the water purification process is found to have a preferred and stable quality that meets the user's taste through the quality detection of the second sensor 24, related parameters can be stored in the corresponding preset scenario of the database 28.

It should be mentioned that the control system 12 can preferably combine the harmful substance removal parameter and the taste adjustment parameter as a control parameter, and transmit the control parameter to the water purification module 26 for execution of the water purification process, but the actual application is not limited thereto. For example, the control system 12 can optionally separate the harmful substance removal parameter and the taste adjustment parameter into two sets of data and transmit them to the water purification module 26, and the water purification module 26 can execute the water purification process twice in accordance with the two sets of data. Generally, the control system 12 can firstly ensure that the water purification process can remove all the harmful substance in the water in accordance with the harmful substance removal parameter; in this situation, if there is the specific substance that can adjust thedrinking tastein the water, the related taste adjustment parameter can be provided to integrate with the harmful substance removal parameter for setting as the control parameter.

In conclusion, the control system of the present application can utilize the first sensor to perform the quality detection in the water supply module of the water filtration device, and transmit the detection result to the logic controller for determining whether there is the harmful substance in the water. If there is the harmful substance in the water, the logic controller can compare the detection value of the harmful substance with the built-in datum of the database, and compute the harmful substance removal parameter that can completely or effectively remove the harmful substance, and the harmful substance removal parameter can be provided to the water purification module for execution of the water purification process. If there is still the specific substance that can adjust the drinking taste in the water after the water purification module performs the water purification process based on the harmful substance removal parameter, the logic controller can compute and acquire the taste adjustment parameter that meets the preset scenario, and integrate the harmful substance removal parameter and the taste adjustment parameter into the control parameter and transmit the control parameter to the water purification module.

On the contrary, if there is no specific substance that can adjust the drinking taste in the water after the water purification module performs the water purification process based on the harmful substance removal parameter, the logic controller can only transmit the harmful substance removal parameter to the water purification module. If the detection result of the first sensor decides that there is no harmful substance in the water, the logic controller can transmit the related taste adjustment parameter to the water purification module in accordance with the preset scenario. During the aforementioned stages, the control system can regularly or irregularly utilize the second sensor to perform the quality detection in the water output module of the water filtration device, and determine whether there is the harmful substance in the water, and further determine whether there is the specific substance that can adjust the drinking taste in the water, thereby immediately transmitting the detection result to the logic controller for the purpose of dynamic suppression.

Moreover, when one or plural users utilize the operation interface of the water filtration device and/or the control system to input and adjust the preset scenario, the control system of the present application can collect and store the adjustment results of the harmful substance removal parameter and/or the taste adjustment parameter of all the preset scenario during the preset period in the database, and analyze the adjustment results to form and store a learning model in the database. Later, the user only needs to input a related code via the operation interface of the water filtration device and/or the control system, and the control system can determine relevant preferences based on the learning model to automatically adjust the harmful substance removal parameter and/or the taste adjustment parameter of the preset scenario, and transmit the adjusted parameters to the water purification module for executing the water purification process and therefore acquiring the drinking water that meets their needs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control system applied for a water filtration device, the control system comprising:
a first sensor disposed on an inlet of the water filtration device to perform quality detection and generate a harmful substance removal parameter;
a water purification module applied for the water filtration device; and
a logic controller electrically connected to the first sensor and the water purification module, the logic controller adjusting the harmful substance removal parameters and a taste adjustment parameter in accordance with a preset scenario, and driving the water purification module to execute a water purification process in accordance with an adjustment result.

2. The control system of claim 1, wherein the logic controller acquires a detection result of the quality detection from the first sensor, and determines whether to generate the harmful substance removal parameter by analyzing the detection result.

3. The control system of claim 2, wherein the control system further comprises a database electrically connected to the logic controller, the logic controller compares the detection result with a built-in datum of the database for computation of the harmful substance removal parameter.

4. The control system of claim 1, wherein the logic controller acquires a detection result of the quality detection from the first sensor, and analyzes the detection result to compute the taste adjustment parameter.

5. The control system of claim 1, wherein the control system further comprises a second sensor electrically connected to the logic controller and disposed on an outlet of the water filtration device to perform the quality detection.

6. The control system of claim 5, wherein the logic controller drives the water purification module based on the harmful substance removal parameter to execute the water purification process for completely removing a harmful substance from liquid contained in the water filtration device, and determines whether there is a specific substance that adjusts drinking taste in the liquid in accordance with a detection result of the quality detection from the second sensor.

7. The control system of claim 6, wherein the logic controller transmits the harmful substance removal parameter and the taste adjustment parameter to the water purification module for executing the water purification process when there is the specific substance that adjusts the drinking taste in the liquid.

8. The control system of claim 6, wherein the logic controller does not transmit the taste adjustment parameter to the water purification module when the liquid does not contain the specific substance that adjusts the drinking taste.

9. The control system of claim 5, wherein the logic controller decides whether to adjust the harmful substance removal parameter and/or the taste adjustment parameter again in accordance with a detection result of the quality detection from the second sensor.

10. The control system of claim 1, wherein the logic controller generates a control parameter by the harmful substance removal parameter and the taste adjustment parameter, and transmits the control parameter to the water purification module.

11. The control system of claim 1, wherein the water purification module is a capacitive deionization module, the logic controller adjusts electric field strength and/or a liquid flow rate of the capacitive deionization module in accordance with the preset scenario for execution of the water purification process.

12. The control system of claim 1, wherein the control system further comprises a database electrically connected to the logic controller, a plurality of preset scenarios is stored in the database, the logic controller collects and stores adjustment results of the harmful substance removal parameter and/or the taste adjustment parameter of each of the plurality of preset scenarios during a preset period into the database, and analyzes the adjustment results to form a learning model inside the database for automatically adjusting the harmful substance removal parameter and/or the taste adjustment parameter of each preset scenario.
